(19) United States
(12) Patent Application Publication
(10) Pub. No.: US 2020/0209870 A1
(43) Pub. Date: Jul. 2, 2020

(54) COLLECTION AND DISTRIBUTION OF ENVIRONMENTAL INFORMATION IN LIMITED ACCESS AREAS

(71) Applicant: Continental Automotive Systems, Inc., Auburn Hills, MI (US)

(72) Inventors: Lubna Khasawneh, Rochester Hills, MI (US); Steffen Hartmann, Royal Oak, MI (US); Dominik Froehlich, Ferndale, MI (US); Ibro Muharemovic, Warren, MI (US); Jeremy McClain, Ortonville, MI (US)

(21) Appl. No.: 16/655,892

(22) Filed: Oct. 17, 2019

Related U.S. Application Data
(60) Provisional application No. 62/785,978, filed on Dec. 28, 2018.

(51) Int. Cl. G05D 1/02; G08G 1/04; G08G 1/01

(52) U.S. Cl. CPC G05D 1/0214; G05D 1/0276; G05D 2201/0216; G08G 1/04; G08G 1/012; G05D 1/0287

(57) ABSTRACT

A disclosed vehicle control system includes a controller disposed within a defined closed area that stores a map with location information for objects within the defined closed area. The controller includes a transceiver for wirelessly transmitting the map in a form usable by navigation systems of vehicles within the defined closed area. A sensor assembly disposed within the defined closed area monitors a location and path of vehicles within the defined closed area and communicate information regarding the location and path of the vehicles to the controller. The controller updates the map responsive to changes in a location of vehicles and other objects within the defined closed area and transmits an updated map to vehicles within the defined closed area.

### CROSS-REFERENCE TO RELATED APPLICATION

This application claims priority to U.S. Provisional Application No. 62/785,978 filed on Dec. 28, 2018.

### TECHNICAL FIELD

The present disclosure relates to a system and method of generating and communicating information for guiding motor vehicles in a defined area.

### BACKGROUND

Motor vehicles sometimes operate in fixed areas of limited access with little room to maneuver. Such areas may include shipping depots, service facilities and parking lots. Space in such fixed areas is limited and make maneuvering large vehicles efficiently difficult. Moreover, changing conditions such as additional vehicles and humans can further complicate movement and result in undesired delays. Although a driver may be alert and competent in the assessment of the best vehicle path through a fixed area, some circumstances and events may be beyond the driver's ability to recognize and perceive changing obstacles and traffic.

Accordingly, it is desirable to design and develop a system that can provide guidance to a vehicle operator as to a most desirable vehicle path.

### SUMMARY

A process for distributing environmental information to vehicles within a defined closed area according to an exemplary embodiment of this disclosure includes, among other possible things, the step of generating a map of a defined closed area that includes information on static structures within the defined closed area, monitoring the defined closed area with a sensor assembly within the closed area for vehicles operating within the defined closed area, dynamically updating the map of the defined closed area to updated the position and path of the vehicles operating within the closed area and an occupied space of static structures within the closed areas based on information from the sensor assembly, and transmitting the map to vehicles operating within the defined closed area for incorporation into an in-vehicle navigation system.

In a further embodiment of the foregoing process, a central controller includes a transceiver and a memory portion including a transmittable version of the map of the defined closed area and the sensor assembly transmits information to the central controller indicative of the position and path of vehicles operating in the defined closed area.

In a further embodiment of any of the foregoing processes, the central controller is configured to receive environmental information relating to operation of vehicles within the defined closed area and continuously integrate the received environmental information relating to the operation of vehicles within the defined closed area.

In a further embodiment of any of the foregoing processes, the central controller is configured to receive environmental information from vehicles operating within the defined closed area.

In a further embodiment of any of the foregoing processes, the controller continuously transmits the map to vehicles within the defined closed area in a form usable by the navigation system of each vehicle.

In a further embodiment of any of the foregoing processes, the controller is configured to transmit a recommended path through the defined closed area to a vehicle entering the defined closed area based on the map.

In a further embodiment of any of the foregoing processes, the recommended path comprises a path to a designated location within the defined closed area.

In a further embodiment of any of the foregoing processes, the vehicle comprises an autonomous vehicle and the controller communicates a path for the autonomous vehicle through the defined closed area to the designated location.

In a further embodiment of any of the foregoing processes, the sensor assembly is mounted to a fixed structure within the defined closed area.

In a further embodiment of any of the forgoing processes, the sensor assembly is mounted to a device moving within the defined closed area.

A vehicle control system for a defined closed area according to another disclosed embodiment includes, among other possible things, a controller disposed within a defined closed area, the controller including a map with location information for objects within the defined closed area and a transceiver for wirelessly transmitting the map in a form usable by navigation systems of vehicles within the defined closed area. The system further includes a sensor assembly disposed within the defined closed area monitoring a location and/or path of vehicles within the defined closed area and communicating information regarding the location and/or path of the vehicles to the controller. The controller updates the map responsive to changes in a location of vehicles and other objects within the defined closed area and transmits an updated map to vehicles within the defined closed area.

In a further embodiment of the foregoing vehicle control system, the controller is configured to receive signals from vehicles within the defined closed area regarding objects within the defined closed area and update the map based on the received signals regarding objects within the defined closed area.

In a further embodiment of any of the foregoing vehicle controls systems, the sensor assembly is disposed on a static structure within the defined closed area.

In a further embodiment of any of the foregoing vehicle controls systems, the sensor assembly is disposed on a moveable device within the defined closed area.

In a further embodiment of any of the foregoing vehicle controls systems, the controller is configured to transmit a recommended path through the defined closed area to a vehicle entering the defined closed area.

In a further embodiment of any of the foregoing vehicle controls systems, the recommended path comprises a path to a designated location within the defined closed area.

In a further embodiment of any of the foregoing vehicle controls systems, the vehicle comprises an autonomous vehicle and the controller is configured to communicate a path for the autonomous vehicle through the defined closed area to the designated location.

In a further embodiment of any of the foregoing vehicle controls systems, the defined closed area comprises a parking lot, distribution center or a warehouse.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic representation of a vehicle control system for a closed area.

FIG. 2 is a schematic representation of process steps for controlling vehicles within a closed area.

### DETAILED DESCRIPTION

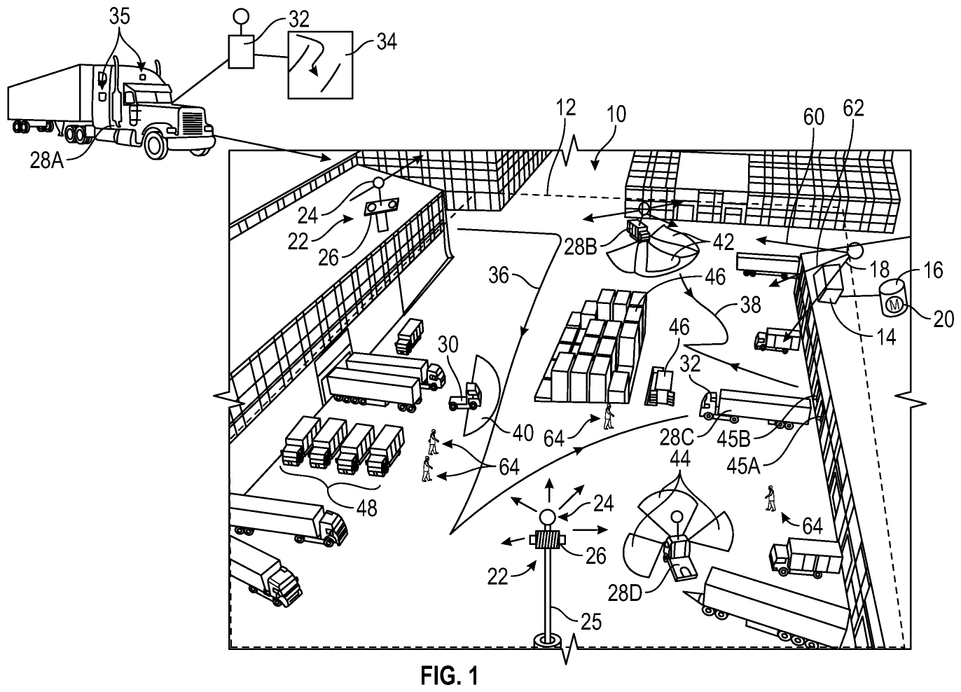

Referring to FIG. 1, a vehicle control system 10 for a closed area 12 is schematically shown and has a controller 14. The controller 14 includes a memory portion 16 that stores a continuously updated map 20. The map 20 is in electronic form and is transmittable wirelessly to vehicles within the closed area 12 to enable and aid in navigation within the closed area based on information obtained from a multiple of sensors within the closed area.

The information is obtained from sensor assemblies within vehicles, static structures or any other feature or object within the closed area. Each sensor within the closed area 12 senses only a part of the entire area within a set and limited field of view. Each sensor assembly transmits these partial observations to the central controller 14. The central controller 14 combines the known static map 20 with the partial observations of different sensor assemblies to generate a continuously and dynamically updated map 20. The controller 14 is fixed within the closed area 12 and can be located within a building, or any other stationary object proximate the area 12. The controller 12 may be any computing device or portion of a computing device capable of receiving, integrating and transmitting information wirelessly to vehicles within the area 12.

The example defined closed area 12 is a warehouse loading area that includes vehicles 28B, 28C and 28D positioned at different locations. The loading area will also include humans 64 that are present throughout and are also recognized and factored into the map 20. The defined closed area 12 also includes stationary permanent objects such as a pole 25 supporting a sensor assembly 22 and stationary temporary objects such as the containers 46. In this example, the containers 46 are disposed between buildings in the defined closed area 12. The term closed area as is used in this disclosure is intended to describe a fixed area where the disclosed system 10 operates. The closed area 12 could be larger or smaller than disclosed depending on the application specific configuration.

Although the containers 46 are stationary, the containers 46 are temporary and will not remain in the specific location. Moreover, vehicles 48 are parked in a location and are also stationary but are temporary. In such closed areas, a map of static features is not entirely useful for recommending paths to vehicles as they move into and out of the closed area due to the temporary static objects and vehicles. Accordingly, the example system 10 uses the sensor assemblies 22 disposed throughout the closed area 12 to observe movement of the vehicles along with obtaining information on temporary fixed objects. Each of the sensor assemblies 22 includes a transceiver 24 to send this information to the central controller 14. The sensor assemblies 22 can transmit information either through a wireless link or through a hardwired link.

The controller 14 also includes a transceiver 18 that both receives information from the sensor assemblies 22 and transmits information for use by vehicles operating within the closed area 12. It should be understood that although a warehouse loading area is disclosed by way of example that other closed areas, such as parking lots, car dealerships, shopping centers, or other defined area would benefit from the disclosed system 10.

In this example, each of the sensor assemblies 22 include cameras 26. The cameras 26 generate images and information indicative of objects within a portion of the closed area 12. As appreciated, the sensor assemblies 22 are limited in the ability to sense objects within the entire area. In one example, the sensor assemblies 22 maybe a LIDAR, Radar or combinations of cameras 26, LIDAR and Radar. Objects such as the containers 46 or the parked vehicles 48 can obstruct portions of the closed area 12. Accordingly, the example controller 14 is further configured to receive information obtained by vehicle environment sensors indicative of objects both moving and stationary within the closed area 12.

In this example, an example vehicle 28A includes a navigation system 32 and sensors 35 that obtain information about the position and path of objects, both moving and fixed, around the vehicle 28A. The system 32 includes a display 34 for displaying a path as well as the location of other objects within the closed area 12. The environmental information obtained by the vehicle 28A is communicated to the controller 14 as long as vehicle 28A operates in the closed area 12. The controller 14 integrates environmental information from the vehicle 28A into the map 20. As additional vehicles 28B, 28D with sensors enter the closed area 12, the controller 14 obtains more information about different portions of the closes area 12. All the information regarding objects and vehicles within the closed area 12 is added to the map 20. The map 20 is therefore continuously updated with new information relevant to a current location of vehicles and objects. The information from each vehicle may include information of the individual vehicles position and path as well as any features or objects around that vehicle.

In this example, vehicles 28B, 28D and 30, all include sensors 35 that obtain information indicative of objects within a range 42, 44 and 40 surrounding the corresponding vehicle 28B, 28D and 30. The information gathered by the vehicles 28B, 28D and 30 is communicated to the central controller 14 and incorporated into the map 20. The map 20 is then communicated by the controller 14 with the transceiver 18 to any vehicles equipped to receive such information. Accordingly, the vehicles 28B, 28D and 30 utilize the information obtained from the controller 14 to generate updated maps of both the vehicles and temporary objects 46 disposed within the closed area 12.

The controller 14 may recognize the vehicles 28B, 28D and 30 based on a unique code that provides access to the closed area 12. As vehicles enter the closed area, the controller 14 can initiate a communication link through a predefined code or other identifier that controls access to information regarding the closed area 12.

The information indicative of objects and vehicles within the closed area 12 can be utilized according to one disclosed embodiment to define and generate a recommended path. In this example, the recommended path 36 is utilized by vehicle 28C to provide path to a defined location. In this example, the defined location is a loading dock bay indicated at 45A. Another vehicle 28B is also utilizing information provided by the controller 14 to define a path 38 to a second loading bay 45B.

Accordingly, the controller 14 continuously receives data generated by the sensor assemblies 22 as well as information transmitted by vehicles 28D and 28B within the closed area indicative of current conditions within the closed area. The controller 14 then utilizes this information to update the map 20 on a continual basis that is then transmitted for use by vehicles as they enter and exit the closed area 12.

Although a vehicle including a sensor can transmit that information to the controller 14, vehicles that do not have a capability of sharing environmental information can benefit from the information provided by the controller 14. In this example, vehicle 28C does not include a system for obtaining information and transmitting that information to the controller 14. However, the vehicle 28C may include a navigation system 32 capable of using information from the controller 14 to determine a path such as the path indicated at 36. The path 36 is generated by the vehicle navigation system with information supplied by the controller 14. In this example, the temporary objects 46 are placed within the area 12 and the vehicle 28C utilizes information from the controller 14 to define the path 36 around the objects 46 to the loading bay 45A.

In this example, another vehicle 28B is utilizing information regarding objects within the closed area 12 to define the path 38 to another defined loading bay location 45B. Accordingly, each of the vehicles within the closed area 12 that have a capability of sensing and determining information about the environment can transmit that information to the controller 14 to update and improve the current accuracy of the map 20 for distribution to vehicles within the closed area 12.

In another disclosed example, an unmanned autonomous vehicle (UAV) 30 travels around the closed area 12 responsive to information gathered by the controller 14. The information gathered by the controller 14 is utilized by the UAV 30 so that it may travel within the closed area 12 with information continuously updated regarding the location of static objects 46 as well as the movements of other vehicles. Moreover, the controller 14 may utilized the information obtained from the various sources within the closed area 12 to define a path of the UAV 30 within the closed area 12.

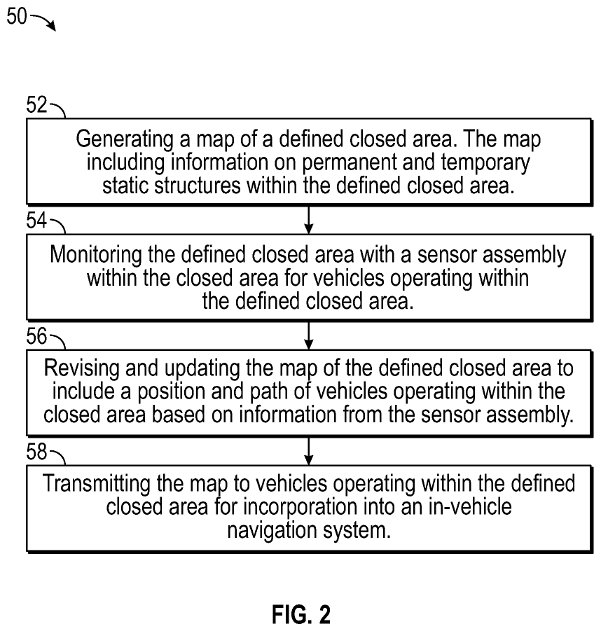

Referring to FIG. 2, with continued reference to FIG. 1, a flow diagram 50 of the example process of distributing environmental information includes a first step 52 of generating a map 20 of the defined closed area 12. The map 20 includes information on permanent and temporary static structures and vehicles moving within the area 12. The information on temporary static structures is obtained by the sensor assemblies 22 as well as from other vehicles 28B and 28D operating within the closed area 12.

The sensor assemblies 22 monitor the defined closed area, as schematically indicated at 54, and provide information relating to the position and occupied space of temporary static structures as well as movements and space of vehicles within the closed area to the controller 14. The controller 14 continuously revises and updates the map 20 as schematically indicated at 56 based on the information gathered by the sensor assemblies 22 regarding vehicles operating within the closed area.

The controller 14 continuously transmits the map 20 in a form useful by systems within each of the vehicles operating within the closed area as is indicated at 58. Each of the vehicles can be equipped with a dedicated system for the closed area 12 and/or can include a generic system that is capable of receiving information from multiple sources. The controller 14 transmits information as wireless signals in a form that is useable by each of the vehicles. The wireless signal 60 can be of any form compatible with communication protocols of systems within the vehicle. The wireless signal 60 can be a publically broadcast signal for receipt by any vehicle within the closed area.

The controller 14 may also emit a dedicated signal 62 that provides a communication link to the UAV 30. The dedicated signal 62 can enable control of the autonomous vehicle 30 within the closed area 12. The vehicle 30 may be directed to specific locations or be instructed to move in a manner that monitors current conditions within the closed area 12. The example UAV 30 is a wheeled vehicle, but may also be an aerial vehicle such as a drone that is capable of monitoring dynamic objects within the closed area 12.

Accordingly, the example system 10 provides a dynamic and continuously updated map 20 of the closed area 12 for use by vehicles moving within the closed area 12.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A process of distributing environmental information to vehicles within a defined closed area, the process comprising:
generating a map of a defined closed area, the map including information on static structures within the defined closed area;
monitoring the defined closed area with a sensor assembly within the closed area for vehicles operating within the defined closed area;
dynamically updating the map of the defined closed area to update a position and path of the vehicles operating within the closed area and an occupied space of static structures within the closed area based on information from the sensor assembly; and
transmitting the map to vehicles operating within the defined closed area for incorporation into an in-vehicle navigation system.

2. The process as recited in claim 1, wherein a central controller includes a transceiver and a memory portion including a transmittable version of the map of the defined closed area and the sensor assembly transmits information to the central controller indicative of the position and path of vehicles operating in the defined closed area.

3. The process as recited in claim 2, wherein the central controller is configured to receive environmental information relating to operation of vehicles within the defined closed area and continuously integrate the received environmental information relating to the operation of vehicles within the defined closed area.

4. The process as recited in claim 3, wherein the central controller is configured to received environmental information from vehicles operating within the defined closed area.

5. The process as recited in claim 3, wherein the controller continuously transmits the map to vehicles within the defined closed area in a form usable by the navigation system of each vehicle.

6. The process as recited in claim 3, wherein the controller is configured to transmit a recommended path through the defined closed area to a vehicle entering the defined closed area based on the map.

7. The process as recited in claim 6, wherein the recommended path comprises a path to a designated location within the defined closed area.

8. The process as recited in claim 5, wherein the vehicle comprises an autonomous vehicle and the controller communicates a path for the autonomous vehicle through the defined closed area to the designated location.

9. The process as recited in claim 1, wherein the sensor assembly is mounted to a fixed structure within the defined closed area.

10. The process as recited in claim 1, wherein the sensor assembly is mounted to a device moving within the defined closed area.

11. A vehicle control system for a defined closed area, the control system comprising:
a controller disposed within a defined closed area, the controller including a map with location information for objects within the defined closed area, the controller including a transceiver for wirelessly transmitting the map in a form usable by navigation systems of vehicles within the defined closed area;
a sensor assembly disposed within the defined closed area monitoring a location and/or path of vehicles within the defined closed area and communicating information regarding the location and/or path of the vehicles to the controller, wherein the controller updates the map responsive to changes in a location of vehicles and other objects within the defined closed area and transmits an updated map to vehicles within the defined closed area.

12. The vehicle control system as recited in claim 11, wherein the controller is configured to receive signals from vehicles within the defined closed area regarding objects within the defined closed area and update the map based on the received signals regarding objects within the defined closed area.

13. The vehicle control system as recited in claim 12, wherein the sensor assembly is disposed on a static structure within the defined closed area.

14. The vehicle control system as recited in claim 13, wherein the sensor assembly is disposed on a moveable device within the defined closed area.

15. The vehicle control system as recited in claim 12, wherein the controller is configured to transmit a recommended path through the defined closed area to a vehicle entering the defined closed area.

16. The vehicle control system as recited in claim 15, wherein the recommended path comprises a path to a designated location within the defined closed area.

17. The vehicle control system as recited in claim 16, wherein the vehicle comprises an autonomous vehicle and the controller is configured to communicate a path for the autonomous vehicle through the defined closed area to the designated location.

18. The vehicle control system as recited in claim 11, wherein the defined closed area comprises a parking lot, distribution center or a warehouse.
